(19) United States
(12) Patent Application Publication
(10) Pub. No.: US 2015/0187112 A1
(43) Pub. Date: Jul. 2, 2015

(54) System and Method for Automatic Generation of Animation

(71) Applicant: Ohad Rozen, Tel Aviv (IL)

(72) Inventor: Ohad Rozen, Tel Aviv (IL)

(73) Assignee: Toonimo, Inc., New York, NY (US)

(21) Appl. No.: 14/141,645

(22) Filed: Dec. 27, 2013

(51) Int. Cl. G06T 13/20; G06T 13/40

(52) U.S. Cl. CPC G06T 13/205; G06T 13/40

(57) ABSTRACT

A system and method for generating animation sequences from either input sound files, input text files or both. A particular embodiment takes an animation sequence of a particular character performing a gesture (such as waving hello) and a sound file, and produces a complete, high-quality, animation sequence with sound and correct lip synchronization. Another embodiment takes an input text file, decodes it to determine one or more gestures, produces a sound file, and then outputs a complete animated sequence with a chosen animation character performing the one or more gestures and mouthing the spoken sounds with correct lip synchronization. Still another embodiment allows entry of a sound file containing multiple spoken gesture keywords. This file can be converted to text or searched for keywords as an audio file. The present invention, as it runs, chooses from a large database of high-quality renderings producing a very high-quality output product.

### BACKGROUND

1. Field of the Invention

The present invention relates generally to the field of animation and more particularly to automatic generation of animation using pre-rendered images with lip sync from a text file containing a particular message.

2. Description of the Prior Art

It is well known in the art to animate humans and animals so that they execute various human-like gestures. It is also known in the art to synchronize animated mouth movements when an animated character talks, sings or otherwise makes audible mouth sounds. This is known in the trade as lip synchronization or simply lip sync, and various commercially available software can take an input sound file and return a set of mouth shapes as outputs along with matching time points. These mouth shapes can then be used with an animated character at the specific time points.

Typically, the rules for lip sync are as follows, whether provided by software, or generated by hand:
In English, the mouth is open for vowels (a, e, i, o, u) The mouth is closes for consonants (b, d, f, m, p, t, v) The mouth is slightly open and the tongue is behind the teeth for (n, d, l, th, t).
Typically, the character's mouth does not change for every letter in a word (or even for every phoneme). Rather, the animator uses mouth changes to capture the important sounds and feeling of the word. For example, memory would not be mouthed as mem-oh-rhee, but rather as mem-ree.
Usually, the mouth changes shape at the first letter or sound of the word and only changes again when the sound is important.
Lip movements are usually run ahead of the sound by one or two frames, never behind.

There are numerous other rules and techniques known in the art for lip sync or causing an animated character to mouth words. In addition to these rules, timing is important. Commercial lip sync software is available that returns a set of mouth shapes and returns a time frame, both based on the sound file. For example, the word “hello” spoken at normal speed might have a time frame output like:

| | |
|---|---|
| 0 sec.-0.1 sec. | Ehh |
| 0.1 sec.-0.15 sec. | L |
| 0.15 sec.-0.3 sec. | O |
| 0.3 sec.-0.4 sec. | U |

As stated, it is also known in the art to cause an animated character to make human-like gestures. For example, in saying “hello”, the character might execute a waving gesture.

Prior art techniques generally use hand-drawn animation for characters and movement with mouth movements also drawn in. Automated prior art uses on-the-fly movement computations and rendering using a rendering engine. This leads to inferior rendering. It would be advantageous to have a system and method that could take an input sound file, and a basic set of animation frames and compose a complete animation sequence including gestures taken from hundreds of pre-rendered images with the correct lip sync mouth movements based on the sound file. It would also be advantageous to have a system and method that could take an input text file along with a choice of an animated character, and generate a complete animated sequence with video and audio components including gesturing and correct lip sync using images from a large set of high quality renderings.

### SUMMARY OF THE INVENTION

The present invention relates to a system and method for generating animation sequences from either input sound files, input text files or both. One embodiment of the present invention takes an animation sequence of a particular character performing a gesture (such as waving hello) and a sound file, and produces a complete animation sequence with sound and correct lip synchronization using high quality rendered images. Another embodiment takes an input text file, decodes it to determine one or more gestures, produces a sound file, and then outputs a complete animated sequence with a chosen animation character performing the one or more gestures and mouthing the spoken sounds with correct lip synchronization. Still another embodiment allows entry of a sound file containing multiple spoken gesture keywords. This file can be converted to text or searched for keywords as an audio file. Finally, gestures can be sequenced, and the final animation sequence produced with correct lip synchronization for each gesture present.

The present invention can produce very high quality animations very quickly, because it chooses from a stored database of high-quality renderings. These renderings cannot be generated on-the-fly; rather, they take a very large amount of time to produce. With numerous high-quality renderings stored in the database at run time, the composition engine can simply choose the best renderings in a very short amount of time as they are needed. This allows the present invention to produce very high-quality animation files using renderings that took hours to prepare in only seconds.

### DESCRIPTION OF THE FIGURES

Several drawings and figures are presented to illustrate features of the present invention:

FIG. 1 shows a block diagram of a first embodiment of the present invention.

FIGS. 2A-2D show a basic animation sequence with four skeleton frames making a hello gesture with the same mouth shape.

FIGS. 3A-3D show for final frames generated during the sequence with a mouth shape for the sound of long “O”.

FIG. 4A shows a frame/time sequence for a skeleton animation.

FIG. 4B shows a frame/time sequence for a final animation.

FIG. 5 shows a block diagram of a second embodiment of the present invention.

Several diagrams, animations, and drawings have been presented to aid in understanding the present invention. The scope of the present invention is not limited to what is shown in the figures.

### DESCRIPTION OF THE PREFERRED EMBODIMENTS

The present invention relates to a system and method for generating animation sequences from either input sound files or input text files. A first embodiment of the present invention takes an animation sequence of a particular character performing a gesture (such as waving hello) and a sound file, and produces a complete animation sequence with sound and correct lip sync.

The present invention chooses from a stored database of high-quality renderings. As previously stated, these renderings cannot be generated on-the-fly; rather, they take a very large amount of time to produce. With numerous high-quality renderings stored in the database at run time, the composition engine can simply choose the best renderings in a very short amount of time as they are needed.

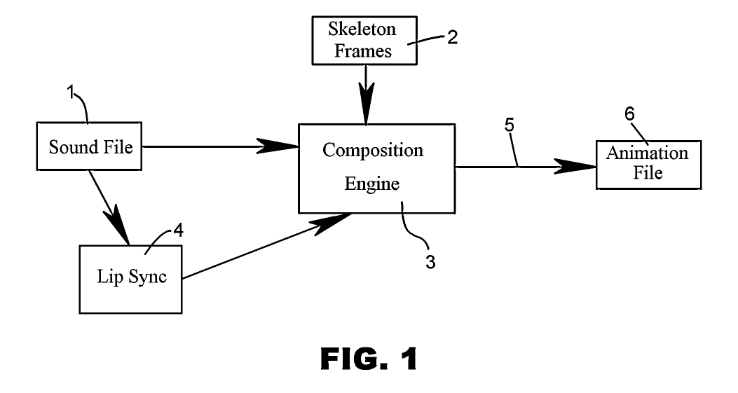

Turning to FIG. 1, a block diagram of this embodiment can be seen. A sound file 1 and a set of skeleton animation frames in a database or file 2 are supplied to a composition engine 3. The sound file 1 is also supplied to a lip sync program 4. The output of the lip sync program is then also supplied to the composition engine 3. The output of the composition engine 3 is a complete animation 5 of a character executing one or more gestures with correct lip sync for the words or phrases in the sound file. The output includes a sound track or synchronized sound file so that the entire animation can be run as a whole. The complete animation 5 can be stored in an output file 6. The chosen images are very high quality since they are chosen from a large set of rendered images of the same character.

As an example, the input sound file might contain the word “Hello”. The basic animation is just a girl waving hello without moving her lips. The animation is typically created by an animator. A user wants to create for his website the same animation, but with the girl saying hello. The user can supply a sound file of a girl saying hello, or one can be recorded. The user can upload the sound file from a remote location over a network like the Internet, choose that particular animation (out of maybe several possible choices) from menus that appear on his computer screen. The system of FIG. 1 then completes the animation with the girl waving hello and saying “hello” with the uploaded sound file with the lips matching the sound. The final images are typically chosen from a very large set of high quality rendered images of the particular animation character. The user can then be supplied with the completed animation file to be displayed on his website using various tools known in the art (such as “Flash” or other tools).

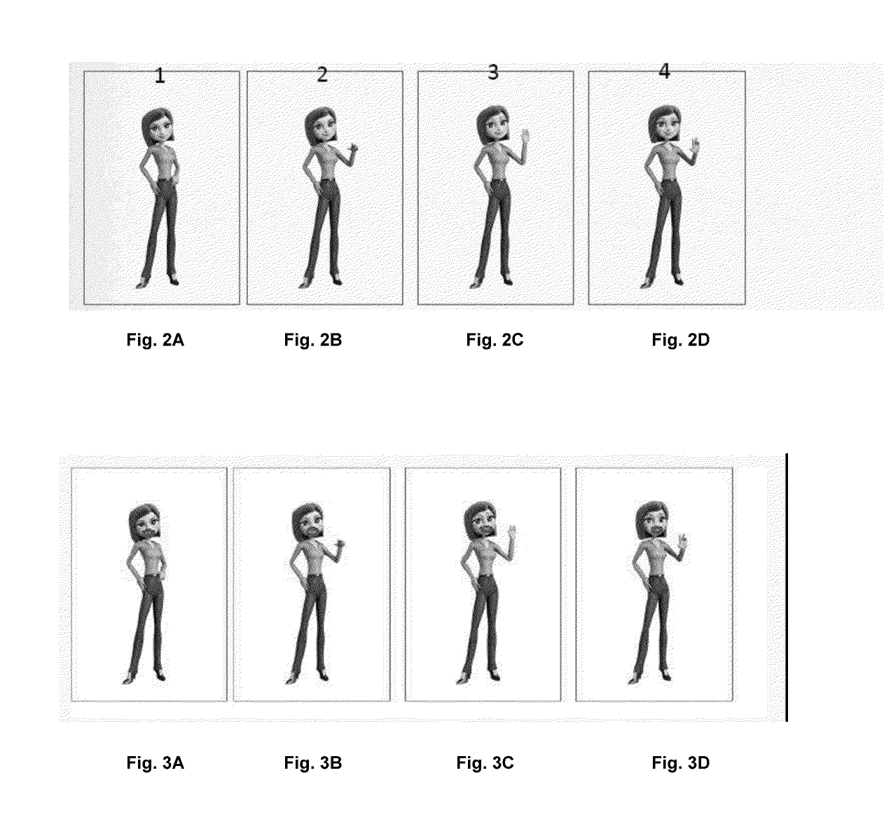

FIGS. 2A-2D show four frames, all with the same mouth shape. In the four frames F1, F2, F3 and F4, the character moves through a gesture (like a hello gesture). The present invention can create an advanced set of the same frames with different mouth shapes. For the mouth shape ‘E’: F1-E, F2-E, F3-E, F4-E; for the mouth shape ‘L’: F1-L, F2-L, F3-L, F4-L; for the mouth shape ‘O’: F1-O, F2-O, F3-O, F4-O; and so on, for all possible mouth shapes. FIGS. 3A-3D show F1-O, F2-O, F3-O, F4-O which are the four basic frames of the gesture with only the mouth shape for ‘O’ superimposed on the character.

After analyzing the uploaded sound file using software such as the lip sync software, and after getting the complete set of frames with all the possible mouth shapes at every point in the gesture, the timing output from the lip sync software is used by the composition engine to calculate which frame has to be picked for each final animation frame.

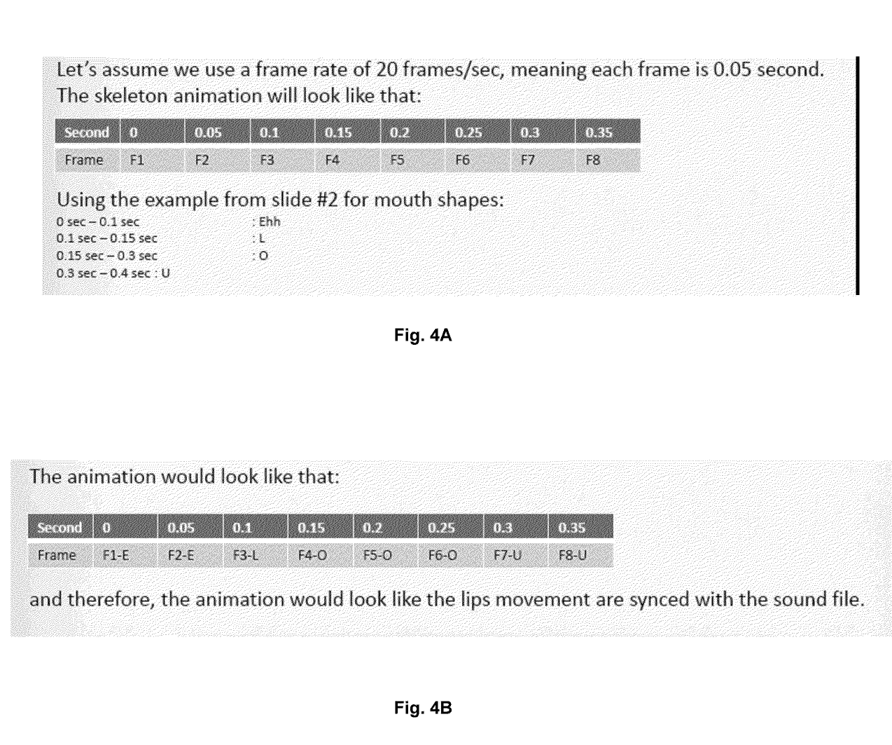

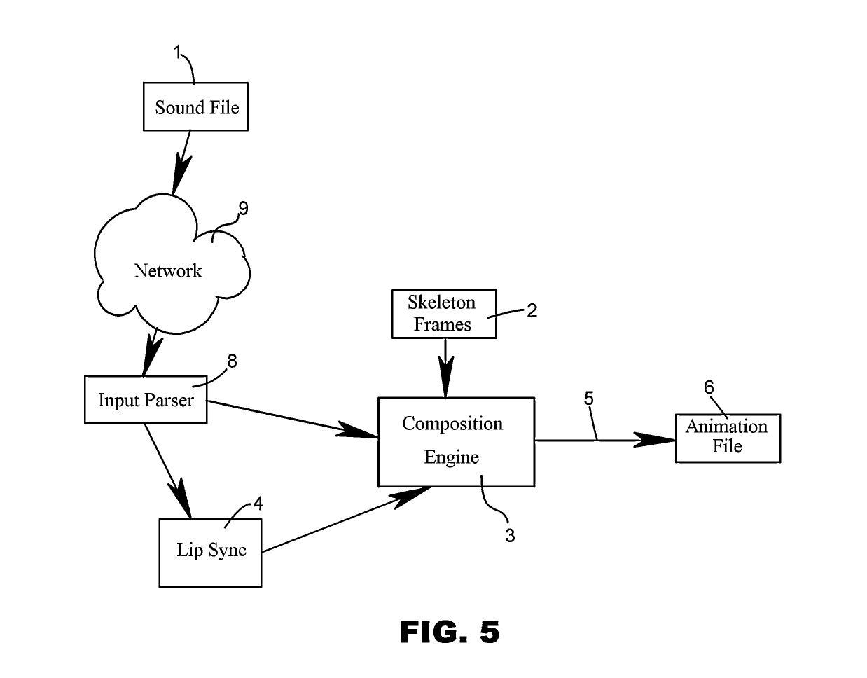

FIG. 4A shows an example that assumes a frame rate of 20 frames/sec which is 0.05 sec. for each frame. The timing of each frame is given as 0.00, 0.05, 0.10, 0.15, 0.20, 0.25, 0.30 and 0.35 seconds.

FIG. 4B shows a final sequence of eight frames on the same timescale, but with the correct mouth movements. Using the example given previously:

| | |
|---|---|
| 0 sec.-0.1 sec. | Ehh |
| 0.1 sec.-0.15 sec. | L |
| 0.15 sec.-0.3 sec. | O |
| 0.3 sec.-0.4 sec. | U |

The eight final frames in this example are: 0.00 F1-E, 0.05 F2-E, 0.10 F3-L, 0.15 F4-O, 0.20 F5-O, 0.25 F6-O, 0.30 F7-U, 0.35 F8-U as shown in FIG. 5. The final animation shows the lip movement synchronized with the supplied sound file.

A second embodiment of the present invention takes an input text file, decodes it to determine one or more gestures and what sounds should be produced, produces a sound component chooses animation frames from a large set of pre-rendered images, and then outputs a complete animated sequence with a chosen animation character performing the one or more gestures and mouthing the spoken sounds with correct lip sync.

Turning to FIG. 5, a block diagram of this embodiment can be seen. In this case an input text file 1 is uploaded over the network 9 and is fed to an input parser 8 that searches the text for predetermined keywords or key phrases. The predetermined keywords or phrases relate to known gestures. An example phrase might be: “Hello. Welcome to my website”. Here, the keywords “hello” and “welcome” can be related to gestures such as waving for hello and a welcome pose for welcome. The sequence of keywords can be fed to the composition engine 3. The remote user can be asked through menus to choose a particular animation character. The database 2 of skeleton frames can store numerous, preformed basic animation sequences with that character representing different gestures according to the predetermined keywords. The images can be taken from a very large set of pre-rendered images of the same animated character. Disk files on a server processing these images can contain large sets of images for many different animated characters.

A sound file 1 can be separately supplied as in the first embodiment, or it can be generated from the text file using techniques known in the art (text to voice). This basic sound file can be enhanced by adjusting accents or stress points from templates of the predefined keywords. Also, punctuation in the text file can be used to get the accents and rising and falling pitch correct. For example, the text: “Hello! might be pronounced differently then the text “Hello.” The text file can optionally be accented to show stress points, for example: h e l l o′ where the pitch rises on the last syllable or: H e′ l l o where the pitch drops on the last syllable. A question mark in the file might show that the last word has a higher pitch, for example: Do you want the best deal in town? requires the word “town” to have a higher pitch than the other words. In some cases, the sound file 1 may need to be adjusted by a human after it is generated.

Once the sound file 1 is supplied or generated, it can be fed to the composition engine 3 and to the lip sync software 4 as in the previous embodiment. The chosen keywords are used to pick pre-stored animation sequences from the skeleton frame database 2. The composition engine 3 can then produce a final animation with the correct sequence of gestures and the correct mouthed words with lip sync. The complete animation 5 can be stored in an output file 6 as before, and also transmitted to the user over the network for use on their website.

The system of the present invention can be stored on a server that is accessible over a network such as the Internet. A user on a computer with a browser can access the system in order to generate animation sequences. Under the control of various menus, boxes and the like, the user can be guided through the process. The user could first be shown a catalog of possible animation characters. These would be characters that have libraries of gesture frames stored for them. The user could choose one or more such characters.

Next, the user might be asked to enter text into a textbox. Alternatively, the user could be shown a library of pre-stored phrases to choose from. These pre-stored phrases can already have completed animation sequences stored for them, or at least templates that allow basic animation sequences to be generated for a particular chosen animation character. Pre-stored phrases could also have associated sound files ready for use. The server can store numerous large sets of high quality pre-rendered images for various animation characters.

If the user chooses freeform text entry, then the system can attempt to parse it and find gesture keywords using a parsing engine. The gesture keywords can have sound bites associated with them for composition into a final sound file. Also, the user could be asked to upload a sound file.

Once a sound file is present or generated, and the gesture sequence is known, the composition engine 3 can put together a connected sequence of gestures that is timed to the location of the keywords in the sound file. Finally, different parts of the sound file that correspond to different keywords can be fed to the lip sync software 4 to generate mouth shapes and timing for each separate gesture. The composition engine 3 can then create a connected, smooth-flowing complete animation sequence corresponding to the entered text. The final output file 6 can be downloaded to the user's computer in a format usable on a webpage or playable on the user's browser.

A third embodiment of the present invention allows the user to upload a sound file containing multiple gesture keywords. This sound file can be searched for gesture keywords either using filters in the audio domain or by converting the sound file to a text file using techniques known in the art (voice recognition —sound to text). The generated text file can be searched for the keywords. A final animation sequence can then be generated from the keyword list and sound file as in the previous embodiment.

Any of these embodiments can run on any computer, especially a server on a network. The server typically has at least one processor executing stored computer instructions stored in a memory to transform data stored in the memory. A communications module connects the server to a network like the Internet or any other network, by wire, fiber optics, or wirelessly such as by WiFi or cellular telephone. The network can be any type of network including a cellular telephone network.

The present invention transforms simple word data and images from pre-rendered sets of hundreds of images into an completed animation sequence with sound and lip sync. The final product is a totally new form that requires considerable computation to achieve.

Several descriptions and illustrations have been provided to aid in understanding the present invention. One with skill in the art will realize that numerous changes and variations may be made without departing from the spirit of the invention. Each of these changes and variations is within the scope of the present invention.

We claim:

1. An animation generation system running on a server connected to a network with at least one memory device comprising:
said server having a processor, memory and a communications module;
an input module executing stored instructions on said server configured to receive a sound file from a remote user over the network and store said sound file in the memory device, said sound file containing at least one spoken word;
an image file of high quality pre-rendered images stored in said memory device;
a input data file stored in the memory device containing a plurality of sequential graphic animation frames from said image file representing an animation character performing a particular gesture associated with said spoken word;
a lip sync module executing on said server adapted to analyze said sound file to produce a sequence of mouth shapes for images from said image file;
a composition module executing on said server adapted to superimpose mouth shapes from said sequence of mouth shapes on said sequential graphic animation frames according to a timing sequence to produce an output animation sequence;
an output module configured to combine said sound file with said output animation sequence to produce an animation output file and transmit said animation output file over the network to said user.

2. The animation generation system of claim 1 wherein said sequential graphic animation frames include a set of frames for each step in said particular gesture, each of said sets of frames including a frame with each possible mouth shape affixed to an animation character at that step.

3. The animation generation system of claim 2 wherein said composition module chooses a correct frame from said set of frames for each step in said gesture according to the sequence of mouth shapes and said timing sequence from said lip sync module corresponding to said word.

4. An animation generation system running on a server connected to a network with at least one attached memory device comprising:
a set of high-quality rendered images stored on said server in said memory device;
an input module executing on said server that receives data from a user over a network and creates a first input data file stored on said memory device containing at least one written phrase;
a second input data file stored on said memory device containing a plurality of high-quality, pre-rendered graphic animation frames;
a parsing engine executing on said server configured to parse said first input data file for predefined written phrase;
a animation composing engine executing on said server adapted to compose an animation sequence from said predefined graphic animation frames based on said written phrase;
a lip sync module executing on said server adapted to assign lip shapes to phonemes of words in said written phrase as well as generating a timing sequence;
an lip movement construction module executing on said server adapted to place said lip shapes onto said animation sequence based on said timing sequence;
an audio/visual module executing on said server and adapted to generate an audio/visual output file stored on said memory device containing spoken words corresponding to said written phrase and a visual animation sequence from said animation sequence and said lip shapes;
an output module executing on said server that communicates said audio/visual output file over the network to said user at a remote location.

5. The animation generation system of claim 4 wherein said predefined graphic animation frames contain images of an animated human.

6. The animation generation system of claim 4 wherein said animation composing engine picks frames from said second input file representing animated human gestures.

7. The animation generation system of claim 6 wherein at least one of the human gestures is a hand wave.

8. The animation generation system of claim 16 wherein at least one of the human gestures is a welcome gesture.

9. A animation system comprising:
a set of high-quality pre-rendered images stored in a memory device;
a processor connected to said memory device;
an input file;
a lip-sync engine running as executable instructions on said processor configured to receive input from a input file;
a composition engine running a executable instructions on said processor configured to receive input from said input file and from said lip-sync engine, said composition engine adapted to access said memory device choosing high-quality rendered images to create an animation file with gestures and synchronized lip movement;
said system configured to store said animation file in said memory device.

10. The animation system of claim 9 wherein said input file contains written text, and said composition engine contains a text-to speech decoder;

11. The animation system of claim 9 wherein said input file is an audio file.

12. The animation system of claim 9 wherein said input file is located remotely from said composition engine and is transmitted to said composition engine over a network.

13. The animation system of claim 9 wherein said set of high-quality rendered images contain skeleton frames of figures performing a plurality of human gestures.

14. The animation system of claim 13 wherein said human gestures include at least a hello gesture and a welcome gesture.

15. A method for converting an input file containing at least one written or spoken phrase into a high-quality animation sequence;
creating a set of high quality, pre-rendered animation images executing a plurality of gestures;
storing said set of high quality animation images on a server in a network, said server having a processor, a memory and a communications module interface;
receiving over the network from a user, an input file that includes at least one spoken or written phrase;
receiving from said user, over the network, a choice of animation figures stored in said set;
parsing said phrase with a parsing engine and choosing particular frames of said set representing animations of gestures associated with said phrase;
executing a lip sync program on said server to synchronize spoken words with each of said chosen frames;
composing a finished animation sequence from said chosen frames and said spoken words and storing this sequence in said memory;
transmitting said finished animation sequence to a user at a remote location over the network.

16. The method of claim 15 wherein an animation character in said finished animation sequence represents a human form.

17. The method of claim 15 wherein said set of high quality, pre-rendered animation images is stored in a database remote from said parsing engine, and is accessible to said parsing engine over the network.

18. The method of claim 15 wherein said input file is an audio file.

19. The method of claim 15 wherein said input file contains at least one text phrase.
